(19) United States
(12) Patent Application Publication
(10) Pub. No.: US 2026/0057232 A1
(43) Pub. Date: Feb. 26, 2026

(54) NEURAL NETWORKS WITH SELF-ADAPTIVE ROBUST ATTENTION

(71) Applicant: Google LLC, Mountain View, CA (US)

(72) Inventors: Isabel Leal, Bellevue, WA (US); Krzysztof Marcin Choromanski, Lincroft, NJ (US); Deepali Jain, Bangalore (IN); Kumar Avinava Dubey, Palo Alto, CA (US); Jacob Joseph Varley, Hastings-on-Hudson, NY (US); Michael Sahngwon Ryoo, Rocky Point, NY (US); Yao Lu, Palo Alto, CA (US); Frederick Liu, Bellevue, WA (US); Vikas Sindhwani, Hastings-on-Hudson, NY (US); Quan Ho Vuong, Palo Alto, CA (US); Tamás Sarlós, Cupertino, CA (US); Kenneth Arthur Oslund, Sunnyvale, CA (US); Karol Hausman, San Francisco, CA (US); Kanury Kanishka Rao, Santa Clara, CA (US)

(21) Appl. No.: 19/305,569

(22) Filed: Aug. 20, 2025

(30) Foreign Application Priority Data
Aug. 20, 2024 (IN) 202411062786

(51) Int. Cl. G06N 3/08

(52) U.S. Cl. CPC G06N 3/08

(57) ABSTRACT

Methods, systems, and apparatus, including computer programs encoded on computer storage media, for controlling an agent interacting with an environment. In one aspect, a method comprises: receiving an observation that characterizes the environment; receiving a conditioning input that characterizes a task to be performed by the agent in the environment; for each of a plurality of sub-regions of the observation, generating an observation patch embedding of the sub-region; generating a conditioning input embedding of the conditioning input; processing the observation patch embeddings and the conditioning input embedding to generate a policy output that defines an action to be performed by the agent in response to the observation, wherein the processing comprises applying a linear attention mechanism over the observation patch embeddings and the conditioning input embedding; selecting an action to be performed by the agent using the policy output; and causing the agent to perform the selected action.

### CROSS-REFERENCE TO RELATED APPLICATION

This application claims the benefit of Indian Provisional Application No. 202411062786, filed on Aug. 20, 2024. The disclosure of the prior application is considered part of and is incorporated by reference in the disclosure of this application.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a policy system implemented as computer programs on one or more computers in one or more locations that controls an agent, e.g., a robot, that is interacting in an environment by selecting actions to be performed by the agent and then causing the agent to perform the actions.

The subject matter described in this specification can be implemented in particular embodiments so as to realize one or more of the following advantages.

Both the time and memory space requirements of applying self-attention across an entire input sequence of elements (e.g., a sequence of observation patch embeddings) grows quadratically with the number of elements in the input sequence (e.g., the time and memory space complexity is O(MN), where M is the number of queries (which are derived from the elements in the input sequence), and N is the number of keys (which are similarly derived from the elements in the input sequence).

Thus, when the policy system is a mobile or embedded control system having limited on-board memory and/or processing resources, it can be infeasible to achieve real-time robot control without significant latency based on applying self-attention to an input sequence of observation patch embeddings when M or N or both are too large.

This specification describes a linear attention mechanism that approximates the quadratic attention mechanism with linear complexity over the context size (e.g., the time and memory space complexity is O(M+N)). Specifically, the linear attention mechanism uses learned projections (i.e., projections applied by using matrices having learned values) and rather than randomly initialized projections (i.e., projections applied by using matrices having randomly initialized values), and an easy-to-compute function (e.g., a ReLU function, an exponential function, or a square root function) that involves less complicated operations than a softmax function to compute the output of the attention mechanism.

This incorporation of linear attention mechanism reduces the resources required to generate the policy output for each observation. The resource savings include less memory consumption and fewer clock cycles. A robot control system can thus become more suitable for on-robot deployment, i.e., deployment on mobile devices, embedded systems, or other hardware platforms with limited computational resources. Because policy outputs are generated more quickly, the robot control system can control the robot to act in a more natural and fluid way, which results in higher precision movements, shorter task completion times, and usability in a wider range of real-world robotic task.

Moreover, the burden on the network bandwidth can be relieved because the robot control system can be deployed more proximate to the robot than a remote system (e.g., a cloud server or another computer system having more memory and/or processing resources), thereby reducing the consumption of network bandwidth that is otherwise required to repeatedly transmit policy outputs from the remote system to the robot. In other words, because the robot control system can achieve a comparable level of control performance as a remote system but can be deployed on-board the robot, transmitting observation data and data identifying the selected actions over network can be avoided.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example policy system and an example control system.

FIG. 2 is an illustration of operations performed by a policy neural network.

FIG. 3 is a flow diagram of an example process for generating a block output by a self-adaptive robust attention (SARA) block.

FIG. 4 is a flow diagram of an example process for training a policy neural network.

FIGS. 5A-B show quantitative examples of the performance gains that can be achieved by using a policy neural network described in this specification compared to a baseline policy neural network.

Like reference numbers and designations in the various drawings indicate like elements.

### DETAILED DESCRIPTION

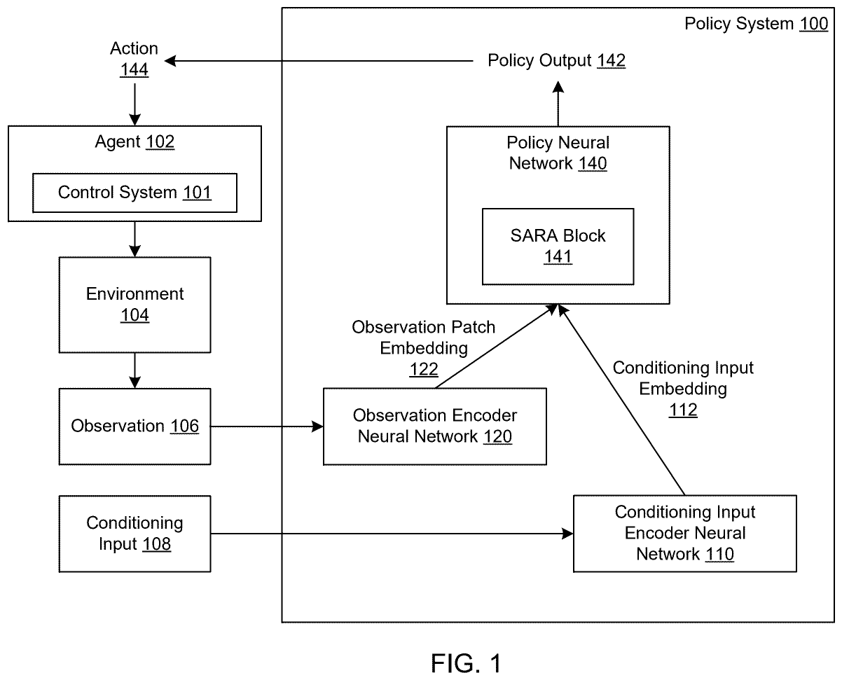

FIG. 1 shows an example policy system 100 and an example control system 101. The policy system 100 and the control system 101 are examples of a system implemented as computer programs on one or more computers in one or more locations in which the systems, components, and techniques described below are implemented.

The policy system 100 and the control system 101 can control an agent 102, e.g., a robot, to accomplish any of a wide variety of tasks in the environment 104. To control the agent 102 that is interacting in the environment 104 to accomplish a task, the policy system 100 selects actions 144 to be performed by the agent 102, and the control system 101 then causes the agent 102 to perform the selected actions 144.

As a few general examples, the task can be a robotic task that includes one or more of, e.g., causing the agent to navigate to different locations in the environment which avoiding obstacle objects along the way, causing the agent to locate different objects, causing the agent to pick up different objects or to move different objects to one or more specified locations, and so on. To accomplish such a task, the agent 102 moves, e.g., navigates and/or changes its configuration, within the environment 104.

Typically, the control system 101 is local to the agent 102. For example, the control system 101 can be on-board the agent 102, e.g., can be implemented on one or more computers, a local workstation, or a local server having relatively small processing and memory resources that is on-board the agent 102, e.g., having limited processing power and/or a constrained memory space.

In some implementations, the policy system 100 is local to the agent 102. For example, like the control system 101, the policy system 100 can also be on-board the agent 102. Moreover, in some of these implementations, the policy system 100 can be a part of the control system 101 which causes the agent 102 to perform actions 144.

In other implementations, the policy system 100 is remote from the agent 102. For example, unlike the control system 101, the policy system 100 can be hosted within a data center, which can be a distributed computing system having hundreds or thousands of computers in one or more locations. That is, the control system 101 can receive data identifying the actions 144 from an external source, e.g., rather than generating such data on-board the agent 102.

In these implementations, the policy system 100 and the control system 101 can be connected by a data communication network, such as a local area network (LAN), a wide area network (WAN), the Internet, or a combination thereof.

In these implementations, the control system 101 of the agent 102 interacts with a remote policy system 100 that is hosted within a data center with much more computing and other resources than those available on-board the agent 102 to reduce the latency in selecting actions 144, reduce the consumption of the limited power supply of the agent 102 when selecting actions 144, or both.

In some implementations, the policy system 100, the control system 101, or both can expose one or more application programming interfaces (APIs) or other data interfaces that facilitate the control of the agent 102.

For example, a user of the agent 102 may use an API made available by the policy system 100 to provide a conditioning input 108 that characterizes the task to be performed by the agent. As another example, the policy system 100 and the control system 101 can interact through an API between the two systems, e.g., the control system 101 can use the API to provide the observations 106 to the policy system 100, and the policy system 100 can use the API to provide data specifying the determined actions 144 to the control system 101.

In particular, at each of a plurality of time steps, the policy system 100 and the control system 101 control the agent based on a policy output 142 for the time step generated by a plurality of neural networks that have been configured through training to control the agent 102 in response to observation data 106 (referred to as an “observation 106”) that includes vision data that characterizes the state of the environment 104 at the time step and a conditioning input 108 that describes or characterizes the task to be performed by the agent 102.

In some implementations, the observation 106 includes an image. The image includes a plurality of pixels. For example, the image can be captured by a camera sensor, e.g., a still camera or a video camera, of the agent 102 or by a camera sensor located in the environment 104.

In some implementations, the observation 106 includes a three-dimensional (3-D) point cloud. The 3-D point cloud includes a plurality of points, with each point having an intensity and a position, and, optionally, other attributes such as color information, second return, or normals. For example, the point cloud can be captured by a LIDAR sensor or a depth camera of the agent 102, or by a LIDAR sensor or a depth camera located in the environment 104.

In some implementations, the observation 106 includes additional data in addition to vision data, e.g., proprioceptive data or other lower-dimensional data generated from data gathered from other types of sensors that makes observation as the agent 102 interacts with the environment 104, or from robot hardware.

Those sensors can include force sensors, electrical connection sensors, acceleration sensors, audio sensors, gyros, contact sensors, radar sensors, and proximity sensors, e.g., infrared proximity sensors, capacitive proximity sensors, or inductive proximity sensors, to name just a few examples. The robot hardware can include actuators, motors, drivers, grippers, to name just a few examples.

Generally, the conditioning input 108 describes or characterizes one or more goals or targets that relates to the task, e.g., a goal state of the environment that should be achieved, or a target object that should be manipulated.

In some implementations, the conditioning input 108 includes a text input in a natural language, e.g., a natural language text sequence that describes the task. The natural language text sequences can be received by the policy system 100 in various ways, including from another agent in the environment 104 or from the control system 101 of the agent.

For example, another agent in the environment 104 can speak an instruction and the control system 101 or another system can transcribe it into a natural language text sequence, and then provide the transcription to the policy system 100.

As another example, the control system 101 can receive an instruction, e.g., a text-based input, a selection-based input, or an audio-based input, entered by a user that specifies the natural language text sequence, and then provide the natural language text sequence to the policy system 100.

As another example, the control system 101 can receive a brain signal input or some other bodily input, e.g., a gesture input, a lip movement input, or a gaze input, that defines or otherwise specifies the natural language text sequence, and then provide the natural language text sequence to the policy system 100.

In some implementations, the conditioning input 108 includes a vision input, e.g., an image or a 3-D point cloud, that characterizes the task to be performed by the agent 102 in the environment 104. The vision inputs can be received by the policy system 100 in various ways, including from a vision sensor system or from the control system 101 of the agent.

For example, the vision input can include an image or a 3-D point cloud that depicts a target object of the task.

As another example, the vision input can include an image or a 3-D point cloud that characterizes a goal state of the environment 104, i.e., that characterizes the state that the environment 104 should reach in order for the task to be successfully completed.

The vision input can characterize the goal state of the environment 104 in various ways.

For example, where the task includes causing the agent 102 to navigate to a target location in the environment 104, the vision input can include an image of the target location in the environment.

As another example, where the task includes causing the agent 102 to locate a target object, the vision input can include an image of the target object that the agent should locate in the environment).

As another example, where the task includes causing the agent 102 to pick up a target object or to move the target object to a specified location, the vision input can include an image of the target object in the specified position in the environment).

The vision inputs can be received by the policy system 100 in various ways.

For example, the policy system 100 can receive the vision input from a vision sensor system, e.g., a vision sensor system included in or connected to the control system 101 of the agent 102.

As another example, the policy system 100 can receive the vision input as an upload from the user over a data communication network, e.g., using an application programming interface (API) made available by the system.

As another example, the policy system 100 can receive an input from the user specifying which image or 3-D point cloud that is stored locally at the policy system 100 or a data store accessible by the policy system 100 over the data communication network should be used as the vision input.

The plurality of neural networks include a conditioning input encoder neural network 110, an observation encoder neural network 120, and a policy neural network 140. As will be described in more detail below, at each of the plurality of time steps, the plurality of neural networks 110, 120, 140 operate in tandem to process the observation 106 and the conditioning input 108 to generate the policy output 142 for the time step.

The conditioning input encoder neural network 110 is configured to process an input that includes a conditioning input 108 to generate a conditioning input embedding 112 of the conditioning input 108 that resides in an embedding space.

As used in this specification, an “embedding” includes one or more tensors, e.g., one or more vectors or matrices, of numeric values, e.g., floating point values or other values. Different tensors included in the embedding include the same, fixed number of numeric values. The number of numerical values in each tensor defines the “dimensionality” of the embedding. The space of possible tensors having the dimensionality is referred to as the “embedding space.”

The conditioning input encoder neural network 110 can have any appropriate architecture including, e.g., one or more embedding neural network layers, feedforward neural network layers, convolutional neural network layers, or attention neural network layers.

As an example, when the conditioning input 108 includes a natural language text sequence, the conditioning input encoder neural network 110 can have a text encoder neural network architecture that includes one or more fully-connected layers, or one or more text Transformer blocks, e g., as described in Vaswani, Ashish, et al. “Attention is all you need.” Advances in neural information processing systems 30 (2017).

As another example, when the conditioning input 108 includes a vision input that includes an image, the conditioning input encoder neural network 110 can have a vision encoder neural network architecture that includes one or more convolutional blocks e.g., one or more ResNet blocks, as described in He, Kaiming, et al. “Deep residual learning for image recognition.” Proceedings of the IEEE conference on computer vision and pattern recognition. 2016, or one or more image Transformer blocks, e.g., as described in Dosovitskiy, Alexey, et al. “An image is worth 16×16 words: Transformers for image recognition at scale.” arXiv preprint arXiv: 2010.11929 (2020).

As another example, when the conditioning input 108 includes a vision input that includes a point cloud, the conditioning input encoder neural network 110 can have a vision encoder neural network architecture that includes one or more point cloud Transformer blocks, e.g., as described in Guo, Meng-Hao, et al. “Pct: Point cloud transformer.” Computational visual media 7.2 (2021): 187-199.

The observation encoder neural network 120 is configured to map the observation 106 to a set of embeddings that resides in the same embedding space as the conditioning input embedding 112.

In some implementations, the observation encoder neural network 120 is configured to, for each of a plurality of sub-regions of the observation 106, process an input that includes the sub-region of the observation 106 to generate an observation patch embedding 122 of the sub-region that resides in the embedding space.

That is, the observation patch embedding 122 includes one or more tensors of numeric values. A tensor included in the observation patch embedding 122 has the same dimensionality as a tensor included in the conditioning input embedding 112.

The observation encoder neural network 120 can have any appropriate architecture including, e.g., one or more embedding neural network layers, feedforward neural network layers, convolutional neural network layers, or attention neural network layers.

As another example, when the observation 106 includes an image, the observation encoder neural network 120 can have a vision encoder neural network architecture that includes one or more convolutional blocks e.g., one or more ResNet blocks, as described in He, Kaiming, et al. “Deep residual learning for image recognition.” Proceedings of the IEEE conference on computer vision and pattern recognition. 2016, or one or more image Transformer blocks, e.g., as described in Dosovitskiy, Alexey, et al. “An image is worth 16×16 words: Transformers for image recognition at scale.” arXiv preprint arXiv: 2010.11929 (2020).

As another example, when the observation 106 includes a point cloud, the observation encoder neural network 120 can have a vision encoder neural network architecture that includes one or more point cloud Transformer blocks, e.g., as described in Guo, Meng-Hao, et al. “Pct: Point cloud transformer.” Computational visual media 7.2 (2021): 187-199.

The policy neural network 140 is configured to process an input that includes (i) the conditioning input embedding 112 generated by the conditioning input encoder neural network 110 based on the conditioning input 108 and (ii) the observation patch embeddings 122 generated by the observation encoder neural network 120 based on the plurality of sub-regions of the observation 106, to generate a policy output 142.

The policy neural network 140 includes one or more self-adaptive robust attention (SARA) blocks 141. As used in this specification, a “block” refers to a group of one or more neural network layers in a neural network.

Each SARA block 141 applies a linear attention mechanism on a block input to generate a block output. This is in contrast to a conventional attention block, e.g., a text Transformer block, an image Transformer block, or a point cloud Transformer block, as mentioned above, which applies a quadratic attention mechanism on a block input to generate a block output.

The linear attention mechanism uses a different transformation function than the quadratic attention mechanism. Instead of applying a softmax function to generate the attention scores, as is commonly used by a conventional attention block, the linear attention mechanism can use a ReLU function, an exponential function, or a square root function as a more computationally efficient alternative to the softmax function.

The policy neural network 140 can include other layers, e.g., one or more embedding neural network layers, feedforward neural network layers, convolutional neural network layers, or other attention blocks.

By virtue of the inclusion of the one or more self-adaptive robust attention (SARA) blocks 141, repeatedly using the plurality of neural networks that includes the policy neural network 140 to generate the policy output 142 at each of the plurality of time steps both consumes fewer computing resources (e.g., memory resources) and is faster in terms of wall-clock time compared to using a baseline policy neural network that uses a quadratic attention mechanism.

The policy output 142 can specify the action 144 in any appropriate way. A few examples are discussed next.

For example, the policy output 142 can include a respective numerical probability value for each action in a set of possible actions that can be performed by the agent. In this example, the policy system 100 could determine the action 144 to be performed by the agent 102, e.g., by sampling an action in accordance with the probability values for the actions, or by selecting the action with the highest probability value.

Analogously, each policy output 142 can assign a respective numerical value for each action dimension in a set of action dimensions, e.g., a set of action dimensions for end effector movement, a set of action dimensions for arm movement, a set of action dimensions for base movement, or some combination of these, and the policy system 100 could determine the action 144 to be performed by the agent 102 from the respective numerical values for the set of action dimensions. The numerical values can be assigned either deterministically, e.g., by the policy output 142, or stochastically, e.g., where the policy output 142 parameterizes a distribution for each action dimension from which the numerical value for the action dimension is sampled.

As another example, each policy output 142 can directly define the action to be performed by the agent, e.g., by defining the values of torques that should be applied to the joints of a robotic agent.

As a particular example, in some implementations, each possible action that can be performed by the agent 102 is defined by a respective value for each of a plurality of action dimensions. In these implementations, for each of the plurality of action dimensions, the policy output 142 can define a respective distribution over possible values for the action dimension.

For example, when the agent 102 is a mobile manipulator robot having a base and one or more arms, where at least one of the arms has an end effector (e.g., a gripper or another tool) attached to its end, the plurality of action dimensions can include 7 action dimensions for arm movement: x, y, z, roll, pitch, yaw, and status of the end effector (e.g., open/close status of the gripper). Optionally, the plurality of action dimensions can also include 3 action dimensions for base movement: x, y, yaw. Optionally, the plurality of action dimensions can further include an action dimension for mode switch (e.g., for switching between controlling an arm of the robot, controlling the base of the robot, or terminating the episode).

In other examples, the agent may be a different type of robot, or it may be a vehicle or another type of agent as mentioned above, and each possible action that can be performed by the agent may thus be characterized by a different set of action dimensions.

In any example, the possible values for each action dimension can be discretized into a fixed number of bins, and the policy output 142 can include one or more tokens that define a distribution over the fixed number of bins for the action dimension. The distribution can be a categorical distribution (a respective discrete probability distribution) that assigns a respective probability score to each bin in the fixed number of bins for the action dimension.

The policy neural network 140 can be configured to auto-regressively generate, as the policy output 142, an output sequence that includes a respective token from a vocabulary of tokens at each of multiple positions.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text.

For each action dimension, the fixed number of bins can correspond to about equal number of possible values for the action dimension. For example, the possible values for the roll (or, analogously, pitch, or yaw) action dimension have a range from 0 to 360 degrees, which be divided into 32 bins (each bin corresponding to a range that spans about 11.25 degrees), 128 bins (each bin corresponding to a range that spans about 2.81 degrees), 256 bins (each bin corresponding to a range that spans about 1.41 degrees), or the like, and thus the policy output 142 can include one of 32 tokens that each represent a different bin in the 32 bins, one of 128 that each represent a different bin in the 128 bins, one of 256 tokens that each represent a different bin in the 256 bins, or the like.

As another example, the possible values for the mode switch action dimension are 0 (controlling an arm of the robot), 1 (controlling the base of the robot), and 2 (terminating the episode), which can be divided into 3 bins (each bin corresponding to a respective value), 256 bins (about 85 bins each corresponding to a same respective value), or the like, and thus the policy output 142 can include one of 3 tokens that each represent a different bin in the 3 bins, one of 256 tokens that each represent a different bin in the 256 bins, or the like.

The policy system 100 selects the action 144 to be performed by the agent 102 using the policy output 142. To select the action to be performed by the agent 102 at the time step, the policy system 100 selects, for each of one or more of the action dimensions, a respective value within the possible values for the action dimension using the respective distribution that is defined by one or more tokens included in the policy output 142.

For example, the policy system 100 can greedily select the highest-scoring bin or can sample, e.g., using nucleus sampling or another sampling technique, a bin from the respective distribution defined by the one or more tokens included in the policy output 142 for an action dimension, and then select a value that corresponds to, e.g., falls within, the selected bin as the selected value for the action dimension.

After having selected the action 144 to be performed by the agent 102, the policy system 100 provides data identifying the selected action 144 to the control system 101.

In some implementations where the policy system 100 is remote from the agent 102, providing the data identifying the selected action 144 can, for example, include transmitting data identifying the selected action 144 over the data communication network that connects the policy system 100 and the control system 101.

Alternatively, in some implementations where the policy system 100 is local to, e.g., on-board, the agent 102, providing the data identifying the selected action 144 can, for example, include transmitting data identifying the selected action 144 over a wired data communication network, e.g., a high-speed data communication link, that connects the policy system 100 and the control system 101.

The control system 101 then causes the agent 102 to perform the selected action 144, e.g., in response to obtaining the observation 106 obtained at the time step. For example, the control system 101 can do this by generating instructions for the agent 102 that when executed will cause the agent 102 to perform the selected action 144, by submitting a control input directly to the appropriate controls of the agent, or by using another appropriate control technique.

At each of the plurality of time steps, the policy system 100 selects an action to be performed by the agent using the policy output and then causes the agent to perform the selected action, e.g., by providing instructions to the agent that when executed cause the agent to perform, by submitting a control input directly to the appropriate controls of the agent, by providing data identifying the action to a control system for the agent, or using another appropriate control technique.

In some implementations, the environment 104 is a real-world environment and the agent 102 is a mechanical agent interacting with the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The actions 144 may be control inputs to control a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions 144 can include for example, position, velocity, or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation, e.g., steering, and movement e.g., braking and/or acceleration of the vehicle.

In some implementations the environment 104 is a simulated environment and the agent 102 is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions 144 may be control inputs to control the simulated user or simulated vehicle. As another example, the simulated environment may be a computer simulation of a real-world environment and the agent may be a simulated robot interacting with the computer simulation.

Generally, when the environment 104 is a simulated environment, the actions 144 may include simulated versions of one or more of the previously described actions or types of actions.

In some implementations, the environment 104 is a suitable execution environment, e.g., a runtime environment or an operating system environment, that is implemented on one or more computing devices such as smart phones, tablet computers, wearable devices, automobile systems, standalone personal assistant devices, and so forth, and the agent 102 is a virtual agent (also known as “automated assistant” or “mobile assistant”) that may be interacted with by a user through the computing devices.

The virtual agent can receive input from the user (e.g., typed or spoken natural language input) and respond with responsive content (e.g., visual and/or audible natural language output). The virtual agent can provide a broad range of functionalities through interactions with various local and/or third-party applications, websites, or other agents.

In these implementations, the actions 144 may include any activity or operation, e.g., a click input, a tap input, a swipe input, a voice input, a gaze input, or a keyboard input, that may be performed or initiated by the user on a computing device, e.g., within an application software installed on the computing device.

In some cases, the policy system 100 can be used to control the interactions of the agent with a simulated environment, and the policy system 100 (or another training system) can train the policy neural network 140 that is used to control the agent 102 based on the interactions of the agent 102 (or another agent) with the simulated environment to determine trained values of the parameters of the plurality of neural networks 110, 120, 140.

In some of these cases, the conditioning input encoder neural network 110, the observation encoder neural network 120, or both can have been pre-trained on some general purpose representation learning tasks and the policy system 100 only trains the policy neural network 140.

After the policy neural network 140 has been trained based on the interactions of the agent 102 (or another agent) with a simulated environment, the trained the plurality of neural networks 110, 120, 140 can be deployed in and used by the policy system 100 to control the interactions of a real-world agent with the real-world environment, i.e., to control the agent that was being simulated in the simulated environment.

Training the policy neural network 140 based on interactions of an agent with a simulated environment (i.e., instead of a real-world environment) can avoid wear-and-tear on the agent and can reduce the likelihood that, by performing poorly chosen actions, the agent can damage itself or aspects of its environment.

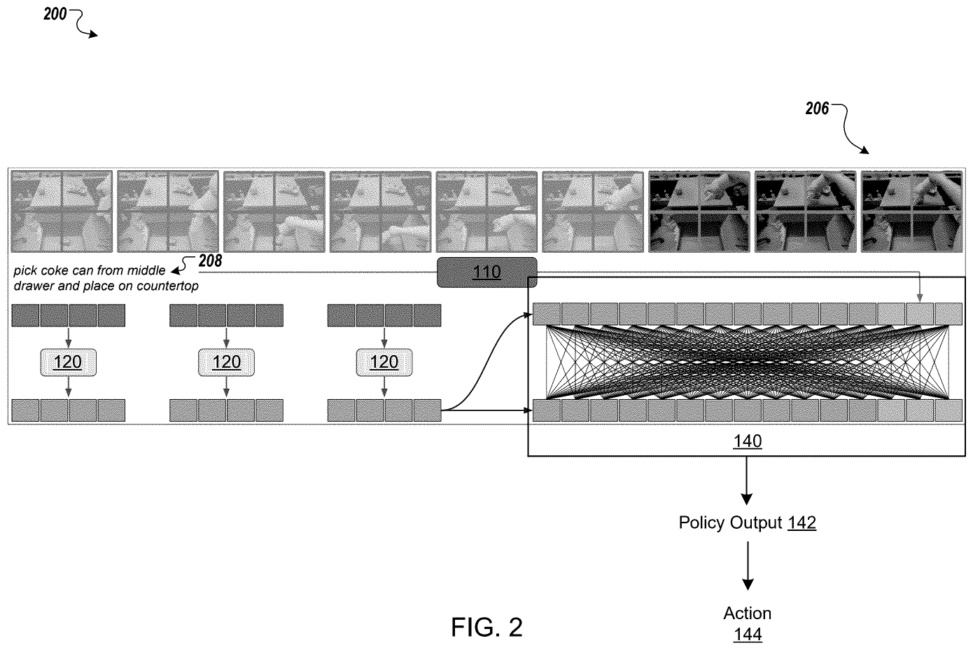

FIG. 2 is an illustration 200 of operations performed by the policy system 100 of FIG. 1 for controlling the agent 102 interacting with the environment 104 at each of a plurality of time steps. By repeatedly performing iterations of the operations described below across the plurality of time steps, the policy system 100 can control the agent 102 to perform a task.

The policy system 100 receives an observation that characterize the state of the environment 104 at the time step. Generally, the policy system 100 obtains different observations across the plurality of time steps. That is, the observation that is received by the policy system 100 may differ from one time step to another.

In some implementations, as illustrated in the example of FIG. 2, the observation includes an image 206. For example, the image can be captured by a camera sensor, e.g., a still camera or a video camera, of the agent or by a camera sensor located in the environment.

In some implementations, the observation includes a three-dimensional (3-D) point cloud. For example, the point cloud can be captured by a LIDAR sensor or a depth camera of the agent, or by a LIDAR sensor or a depth camera located in the environment.

The policy system 100 receives a conditioning input that characterizes the task to be performed by the agent in the environment.

In some cases, the policy system 100 receives the same conditioning input across the plurality of time steps. For example, the conditioning input can be a natural language text sequence that defines a long-horizon goal for an entire episode.

An episode is generally a time period during which the agent attempts to perform the specified task. It may be defined by a particular number or threshold number of time steps, and/or may continue until some other termination criterion has been satisfied, e.g., a termination signal is received indicating that the task has successfully been performed.

For example, the natural language text sequence can be a natural language instruction that is in the format of: “pick object”, “knock object over”, “open/close drawer”, “place object into receptacle”, “place object upright”, “move object near object”, “pick object from receptacle and place on the counter”. For example, in FIG. 2, the conditioning input includes a natural language text sequence that is a natural language instruction 208: “pick code can from middle drawer and place on countertop.”

In other cases, the policy system 100 obtains different conditioning inputs across the plurality of time steps. For example, the conditioning input can be a natural language text sequence, and the control system 101 or another system can repeatedly update the natural language text sequence, i.e., generates an updated natural language text sequence, at each of the plurality of time steps, e.g., based on the previous action performed by the agent, the previous state of the environment, or both at a previous time step, and provide the updated natural language text sequence to the policy system 100. In this example, the natural language text sequences may describe an immediate goal, e.g., “move the robot forward,” “reach the target location (x, y),” or the like.

As another example, a user may provide an updated natural language text sequence after the episode has begun in response to the user providing an initial natural language text sequence, and thus the policy system 100 receives the initial natural language text sequence at each of some of the plurality of time steps, and obtains the updated natural language text sequence at each of others of the plurality of time steps.

For each of a plurality of sub-regions of the observation, the policy system 100 process an input that includes the sub-region of the observation using the observation encoder neural network 120 to generate an observation patch embedding of the sub-region that resides in an embedding space.

That is, the policy system 100 uses the observation encoder neural network 120 to generate an output that includes a respective observation patch embedding for each of the plurality of sub-regions of the observation.

Each sub-region corresponds to a subset of the observation. For example, where the observation includes an image that includes a plurality of pixels, each sub-region (“image patch”) can include a different subset of the plurality of pixels of the image. For example, in FIG. 2, the image 206 includes a total of four sub-regions (four image patches) at different positions (top left, top right, bottom left, bottom right) within the image 206.

As another example, where the observation includes a point cloud that includes a plurality of points, each sub-region (“point cloud patch”) can include a different subset of the plurality of points of the point cloud. In some implementations, each pixel in the image (or, analogously, each point in the point cloud) is included in exactly one of the plurality of sub-regions of the observation.

The policy system 100 process the conditioning input using the conditioning input encoder neural network 110 to generate a conditioning input embedding of the conditioning input that resides in the same embedding space as the observation patch embeddings.

Thus, in the case where the observation includes an image and the conditioning input include a natural language text sequence, the policy system 100 maps the observation and the conditioning input to a co-embedding space that includes the embedded representations of data in different modalities.

In some implementations, the input to be processed by the observation encoder neural network 120 to generate the observation patch embeddings includes the conditioning input embedding.

That is, the observation encoder neural network 120 uses the conditioning input embedding as context when generating the observation patch embeddings, i.e., so that different conditioning inputs can result in different observation patch embeddings being generated for the same sub-region of the observation.

The policy system 100 process an input that includes (i) the conditioning input embedding generated by the conditioning input encoder neural network 110 based on the conditioning input and (ii) the observation patch embeddings generated by the observation encoder neural network 120 based on the plurality of sub-regions of the observation, using policy neural network 140, to generate a policy output 142.

In some implementations, the input to be processed by the policy neural network 140 includes the observation patch embedding that has been generated by the observation encoder neural network 120 for each of a plurality of sub-regions of each of one or more historic observations obtained preceding the observation.

For example, the input to the policy neural network 140 can also include the observation patch embedding for each of a plurality of sub-regions of the historic observation obtained at each of one or more preceding time steps that precede the time step in the plurality of time steps.

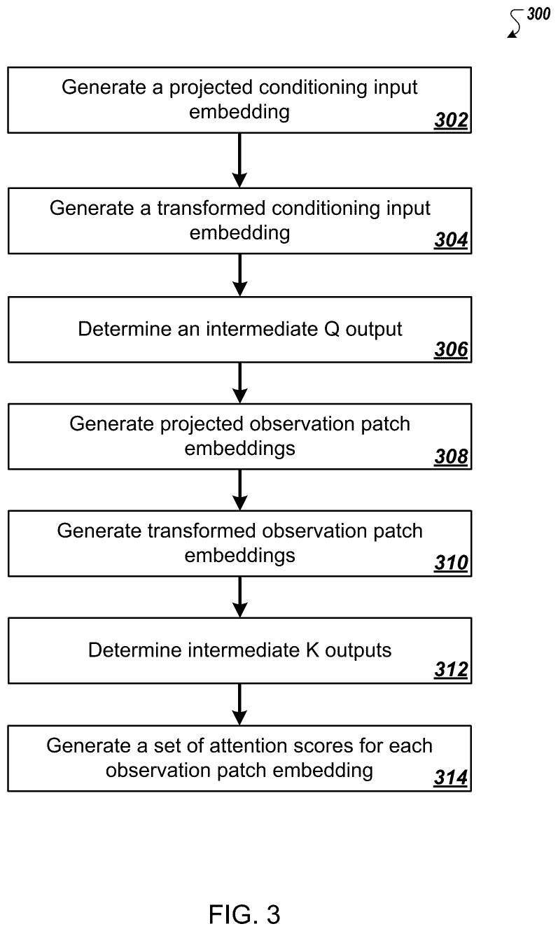

The policy neural network 140 includes one or more SARA blocks 141 that each apply a linear attention mechanism, e.g., in place of a quadratic attention mechanism. How the policy neural network 140 operates to generate the policy output 142 based on applying a linear attention mechanism will be described below in FIG. 3.

The policy system 100 selects an action 144 to be performed by the agent 102 at the time step using the policy output 142. In some implementations, this selection can be made by selecting a respective value for one or more of the plurality of action dimensions using the respective categorical distributions that are defined by the policy output 142 of the policy neural network 140.

The policy system 100 causes the agent 102 to perform the selected action 144 at the time step, e.g., by directly submitting the control input to the agent or by transmitting instructions or other data, e.g., over a data communication network, to the control system 101 for the agent that will cause the agent to perform the selected action.

FIG. 3 is a flow diagram of an example process 300 for generating a block output by a self-adaptive robust attention (SARA) block based on applying a linear attention mechanism on a block input. For convenience, the process 300 will be described as being performed by a system of one or more computers located in one or more locations. For example, a policy system, e.g., the policy system 100 depicted in FIG. 1, appropriately programmed in accordance with this specification, can perform the process 300.

In general, the system receives a block input at the SARA block and processes the block input using the SARA block by performing, at each of one or more attention heads in the SARA block, an iteration of process 300 to generate a block output. The block input can be any intermediate data generated by the policy neural network when generating the policy output.

For example, when the SARA block is the first block in a sequence of SARA blocks, the block input can include (i) the conditioning input embedding generated by the conditioning input encoder neural network based on the conditioning input and (ii) the observation patch embeddings generated by the observation encoder neural network based on the plurality of sub-regions of the observation; or an embedded representation of (i) and (ii) generated by one or more preceding layers included in the policy neural network.

As another example, when the SARA block is a subsequent block in the sequence of SARA blocks, the block input can include a block output generated by a preceding SARA block in the sequence of SARA blocks.

The system processes, using a query transformation layer in the attention head of the SARA block, a first block sub-input derived from the block input to generate a projected first block sub-input (step 302).

The query transformation layer is configured to apply a learned Q matrix having values learned as a result of training to the first block sub-input to generate the projected first block sub-input. Different attention heads of the SARA block generally include different query transformation layers and hence, applies Q matrices that have different values.

How the first block sub-input is derived from the block input depends on the configuration of the policy neural network, as well as on the attention mechanism that the SARA block is configured to perform.

For example, when the SARA block is the first block in a sequence of SARA blocks, the first block sub-input can be a portion of the block input that includes the conditioning input embedding.

As another example, when the SARA block is a subsequent block in a sequence of SARA blocks, the first block sub-input can be a portion of the block input that includes an updated conditioning input embedding generated by a preceding SARA block in the sequence of SARA blocks.

The system processes, using a transformation layer in the attention head of the SARA block, the projected first block sub-input to generate a transformed first block sub-input (step 304).

The transformation layer is configured to apply a transformation function on the projected first block sub-input to generate the transformed first block sub-input. For example, the transformation function can be one of: a ReLU function, an exponential function, or a square root function. Different attention heads of the SARA block can use the same or different transformation functions.

The system computes, using a multiplication layer in the attention head of the SARA block, a product between (i) a learned value vector having values learned as the result of the training and (ii) the transformed first block sub-input (step 306). Different attention heads of the SARA block generally include value vectors that have different values.

For example, the product can be computed as:

$${ϕ}_{f , 1}^{SARA} ( z ) = v ⊙ f ( {G}_{Q} z ) ,$$

where ⊙ represents a Hadamard product, z represents the first block sub-input, G_{Q} represents the learned Q matrix applied by the query transformation layer, and f represents the transformation function. The product is then provided as the intermediate Q output.

For each of the plurality of observation patch embeddings, the system processes, using a key transformation layer in the attention head of the SARA block, a respective second block sub-input derived from the block input to generate a respective projected second block sub-input (step 308).

The key transformation layer is configured to apply a learned K matrix having values learned as the result of the training to the respective second block sub-input to generate the respective projected second block sub-input. Different attention heads of the SARA block generally include different key transformation layers and hence, applies K matrices that have different values.

How the respective second block sub-inputs are derived from the block input depends on the configuration of the policy neural network, as well as on the attention mechanism that the SARA block is configured to perform.

For example, when the SARA block is the first block in a sequence of SARA blocks, the respective second block sub-input can be a portion of the block input that includes the observation patch embedding.

As another example, when the SARA block is a subsequent block in a sequence of SARA blocks, the respective second block sub-input can be an updated observation patch embedding generated by a preceding SARA block in the sequence of SARA blocks.

For each of the plurality of observation patch embeddings, the system processes, using a transformation layer in the attention head of the SARA block, the respective projected second block sub-input to generate a respective transformed second block sub-input (step 310).

The transformation layer is configured to apply a transformation function on the respective projected second block sub-input to generate the respective transformed second block sub-input. For example, the transformation function can be one of: a ReLU function, an exponential function, or a square root function. Different attention heads of the SARA block can use the same or different transformation functions.

For each of the plurality of observation patch embeddings, the system computes, using a multiplication layer in the attention head of the SARA block, a product between (i) a learned value vector having values learned as the result of the training and (ii) the respective transformed second block sub-input (step 312). Different attention heads of the SARA block generally include value vectors that have different values.

For example, the product for each of the plurality of observation patch embeddings can be computed as:

$${ϕ}_{f , 2}^{SARA} ( z ) = v ⊙ f ( {G}_{K} z ) ,$$

where ⊙ represents a Hadamard product, z represents a respective second block sub-input, G_{K} represents the learned K matrix applied by the key transformation layer, and f represents the transformation function. The product is then provided as the intermediate K output for the observation patch embedding.

The system generates, using the attention head of the SARA block, a set of attention scores for each of the plurality of observation patch embeddings from (i) the intermediate Q output and (ii) the intermediate K output for the observation patch embedding (step 314).

To generate the set of attention scores for each observation patch embedding, the system computes, using a multiplication layer in the attention head of the SARA block, a product between (i) the intermediate Q output and (ii) the intermediate K output for the observation patch embedding, and then computes, using a normalization layer in the SARA block, a division of this product by a sum of a respective product between (i) the learned value vector and (ii) the respective transformed second block sub-input for each of the plurality of observation patch embeddings.

The respective products can be computed linearly, i.e., with linear time and memory space complexity. For example, the respective products can be computed as dot products:

$${{ϕ}_{f , 1}^{SARA} ( {x}_{i} )}^{⊤} {ϕ}_{f , 2}^{SARA} ( {y}_{j} ) ,$$

where x and y represent the first and second block sub-inputs, respectively.

Having performed an iteration of process 300 at each of one or more attention heads in the SARA block, e.g., in parallel, the system generates the block output of the SARA block and based on the set of attention scores for each of the plurality of observation patch embeddings generated by each of the one or more attention heads in the SARA block.

In some implementations, the block output can be generated by, for each of the one or more attention heads in the SARA block, generating an initial block output based on computing a product between (i) the set of attention scores for each of the plurality of observation patch embeddings and (ii) the block input or data derived from the block input, and then combining the initial block outputs of the one or more attention heads, e.g., by concatenating the initial block outputs and, optionally, processing the concatenated outputs through a linear layer.

By repeatedly performing iterations of the process 300 for all of the SARA blocks in the policy neural network and then by processing at least part of the block output generated by the last SARA block in the sequence of SARA blocks using one or more output layers, the system can the policy output for the time step.

For example, an output layer of the policy neural network can process (i) the block output generated by the last SARA block and (ii) action data that defines a set of base actions that can be performed by the agent when interacting with the environment to generate the policy output. For example, each base action can correspond to an action dimension in the set of action dimensions, as discussed above.

The process 300 can be performed when controlling an agent to perform a task in which the actions that should be performed, e.g., actions that would result in progression towards accomplishing the task, are not known. The process 300 can also be performed as part of selecting actions to be performed by an agent based on processing observations derived from a set of training dataset, i.e., observations the actions in response to which that should be performed by the agent is known, in order to train the policy neural network to determine trained values for the parameters of the policy neural network.

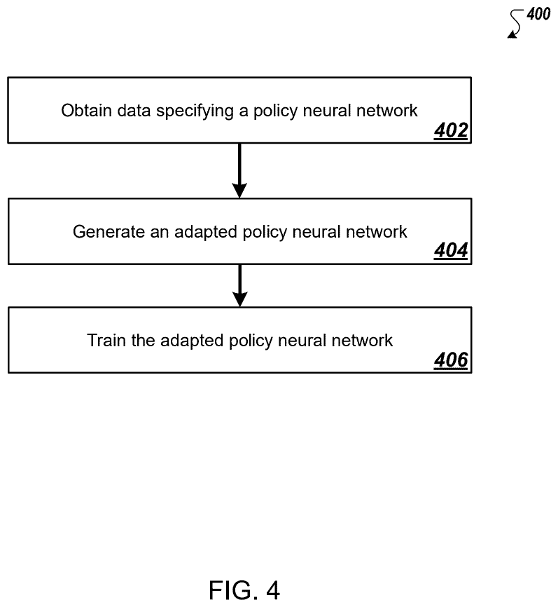

FIG. 4 is a flow diagram of an example process 400 for training a policy neural network. For convenience, the process 400 will be described as being performed by a system of one or more computers located in one or more locations. For example, a policy system, e.g., the policy system 100 depicted in FIG. 1, appropriately programmed in accordance with this specification, can perform the process 400. As another example, a training system that is separate from the policy system, appropriately programmed in accordance with this specification, can perform the process 400.

The system obtains data specifying that specifies a trained policy neural network (step 402). The data can include architecture data specifying the architecture of the policy neural network, and parameter data specifying trained values of the parameters of the policy neural network that are determined as a result of the training of the policy neural network, e.g., on a variety of robotics training dataset and, in some implementations, vision-language training datasets.

The policy neural network includes a plurality of attention blocks, e.g., a plurality of text Transformer blocks, a plurality of image Transformer blocks, or a plurality of point cloud Transformer blocks. Each such attention block applies a quadratic attention mechanism on a block input to generate a block output.

For example, the policy neural network can have one of the policy neural network architectures described in Brohan, Anthony, et al. “Rt-1: Robotics transformer for real-world control at scale.” arXiv preprint arXiv: 2212.06817 (2022), and Zitkovich, Brianna, et al. “Rt-2: Vision-language-action models transfer web knowledge to robotic control.” Conference on Robot Learning. PMLR, 2023.

The system generates an adapted policy neural network by replacing at least one of the plurality of attention block with a self-adaptive robust attention (SARA) block (step 404). Thus, the adapted policy neural network includes the SARA block in place of an attention block that was originally included in the trained policy neural network. The SARA block includes parameters that define the values of V vector, the values of a Q matrix, and the values of a K matrix.

The system trains the adapted policy neural network on agent control task training data for a task (step 406).

In some implementations, the agent control task training data includes data characterizing interactions of one or more expert agents with a corresponding environment with performing the task. An expert agent can be any agent that selects actions in response to observations in accordance with an action selection policy that cause the expert agent to make effective progress towards accomplishing a task. For example, the expert agent may be an agent controlled by another already trained policy system, a person who is skilled at the task to be performed by the agent, and so forth.

For example, the agent control task training data for a task can include, for each episode of the task during which an expert agent performs the task, a plurality of training examples that correspond respectively to a plurality of time steps during the episode. Each training example includes an observation that characterizes the state of the environment at the time step and expert policy output that defines an expert action performed in response to the observation.

In this example, the system can train the adapted policy neural network based on optimizing an objective function that measures, for each training example, a difference between (i) the expert policy output and (ii) a training policy output generated by the adapted policy neural network based on processing the observation included in the training example.

For example, the training policy output can be an output sequence that includes multiple positions, and the objective function can be a cross-entropy objective function, or another objective function, that evaluates, for each output position, a difference between a training distribution over a vocabulary of tokens generated by the adapted policy neural network and a ground truth distribution that specifies a ground truth token at the position.

In some implementations, the training of the adapted policy neural network involves learning updated values of the parameters of the SARA block, including learning updated values of the parameters that define the V vector, the Q matrix, and the K matrix, while holding the trained values of the remaining components of the policy neural network that are determined as a result of the training of the policy neural network fixed.

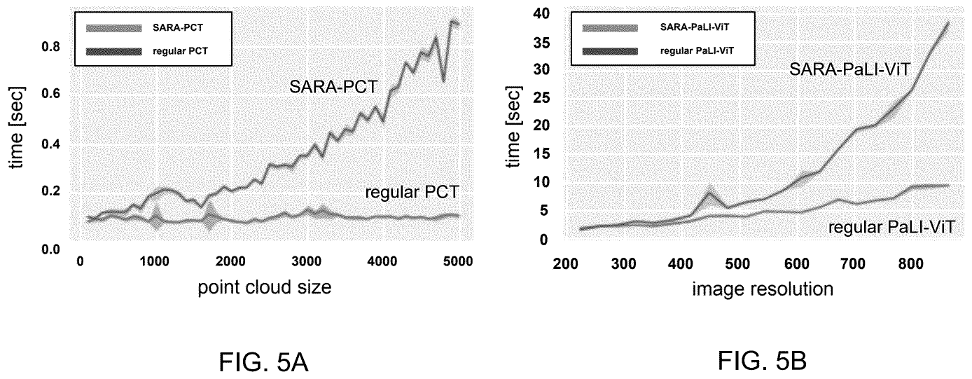

FIGS. 5A-B show quantitative examples of the performance gains that can be achieved by using a policy neural network described in this specification compared to a baseline policy neural network.

FIG. 5A shows the mean inference time (average time needed to perform a single forward pass through the neural network; on a CPU, averaged over 1=10 random seeds) for two policy neural networks (as well as the corresponding standard deviations illustrated as shaded regions) as a function of the size of the point clouds. The two policy neural networks include a policy neural network that includes one or more SARA blocks (SARA-PCT), and a baseline policy neural network that does not include any SARA blocks (regular PCT).

FIG. 5B shows the mean inference time (average time needed to perform a single forward pass through the neural network; on a CPU, averaged over 1=10 random seeds) for two policy neural networks (as well as the corresponding standard deviations illustrated as shaded regions) as a function of the resolution of the image when operating on 16×16 image patches. The two policy neural networks include a policy neural network that includes one or more SARA blocks (SARA-PaLI-ViT), and a baseline policy neural network that does not include any SARA blocks (regular PaLI-ViT).

The policy neural networks that include one or more SARA blocks outperform the baseline policy neural networks that do not include any SARA blocks in terms of inference time when processing both point clouds and images. The greater the point cloud size or the higher the image resolution, the more significant the inference speed improvement.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for controlling an agent interacting with an environment, the method comprising:
receiving an observation that characterizes the environment;
receiving a conditioning input that characterizes a task to be performed by the agent in the environment;
for each of a plurality of sub-regions of the observation, generating an observation patch embedding of the sub-region in an embedding space;
generating a conditioning input embedding of the conditioning input in the embedding space;
processing the observation patch embeddings and the conditioning input embedding to generate a policy output that defines an action to be performed by the agent in response to the observation, wherein the processing comprises applying a linear attention mechanism over the observation patch embeddings and the conditioning input embedding;
selecting an action to be performed by the agent using the policy output; and
causing the agent to perform the selected action.

2. The method of claim 1, wherein applying the linear attention mechanism comprises:
applying a learned Q matrix having values learned as a result of training to the conditioning input embedding to generate a projected conditioning input embedding;
determining an intermediate Q output based on the projected conditioning input embedding; and
for each of the plurality of observation patch embeddings:
applying a learned K matrix having values learned as the result of the training to the observation patch embedding to generate a projected observation patch embedding; and
determining an intermediate K output based on projected observation patch embedding.

3. The method of claim 2, wherein determining the intermediate Q output based on the projected conditioning input embedding comprises:
processing the projected conditioning input embedding using a transformation function to generate a transformed conditioning input embedding; and
determining the intermediate Q output based on computing a product between (i) a learned V vector having values learned as the result of the training and (ii) the transformed conditioning input embedding.

4. The method of claim 2, wherein determining the intermediate K output based on projected observation patch embedding comprises:
for each of the plurality of observation patch embeddings:
processing the projected observation patch embedding using the transformation function to generate a transformed observation patch embedding; and
determining the intermediate K output based on computing a product between (i) the learned V vector and (ii) the transformed observation patch embedding.

5. The method of claim 1, wherein processing the observation patch embeddings and the conditioning input embedding to generate the policy output comprises:
generating a set of attention scores from (i) the intermediate Q output and (ii) the intermediate K output for each of the plurality of observation patch embeddings; and
processing at least the set of attention scores to generate the policy output.

6. The method of claim 1, wherein the conditioning input comprises a natural language text sequence that describes the task.

7. The method of claim 1, wherein the conditioning input comprises a vision input that depicts a target object of the task.

8. The method of claim 3, wherein the transformation function comprises one of: a ReLU function, an exponential function, or a square root function.

9. The method of claim 1, wherein the observation that characterizes the environment comprises an image that characterizes the environment, and wherein each of the plurality of sub-regions of the observation include a subset of pixels of the image.

10. The method of claim 1, wherein the observation that characterizes the environment comprises a point cloud that characterizes the environment, and wherein each of the plurality of sub-regions of the observation include a subset of points of the point cloud.

11. The method of claim 1, wherein generating the policy output comprises processing action data defining a set of base actions that can be performed by the agent when interacting with the environment.

12. The method of claim 1, wherein the policy output comprises, for each of a plurality of action dimensions, a respective categorical distribution over possible values for the action dimensions.

13. The method of claim 12, wherein selecting an action to be performed by the agent using the policy output comprises selecting a respective value for one or more of the action dimensions using the respective categorical distributions.

14. The method of claim 1, further comprising:
obtaining data specifying an initial policy neural network comprising a plurality of attention blocks;
generating a policy neural network used to control the agent interacting with the environment, wherein the policy neural network comprises a self-adaptive robust attention (SARA) block in place of at least one of the plurality of attention blocks, the SARA block comprising parameters defined by a V vector, a Q matrix, and a K matrix; and
training the policy neural network on agent control task training data, including learning values of parameters defined by the v vector, the Q matrix, and the K matrix.

15. The method of claim 14, wherein the data specifying the initial policy neural network comprises data specifying pre-trained parameter values of the initial policy neural network.

16. A system comprising one or more computers and one or more storage devices storing instructions that are operable, when executed by the one or more computers, to cause the one or more computers to perform operations for controlling an agent interacting with an environment, the operations comprising:
receiving an observation that characterizes the environment;
receiving a conditioning input that characterizes a task to be performed by the agent in the environment;
for each of a plurality of sub-regions of the observation, generating an observation patch embedding of the sub-region in an embedding space;
generating a conditioning input embedding of the conditioning input in the embedding space;
processing the observation patch embeddings and the conditioning input embedding to generate a policy output that defines an action to be performed by the agent in response to the observation, wherein the processing comprises applying a linear attention mechanism over the observation patch embeddings and the conditioning input embedding;
selecting an action to be performed by the agent using the policy output; and
causing the agent to perform the selected action.

17. The system of claim 16, wherein applying the linear attention mechanism comprises:
applying a learned Q matrix having values learned as a result of training to the conditioning input embedding to generate a projected conditioning input embedding;
determining an intermediate Q output based on the projected conditioning input embedding; and
for each of the plurality of observation patch embeddings:
applying a learned K matrix having values learned as the result of the training to the observation patch embedding to generate a projected observation patch embedding; and
determining an intermediate K output based on projected observation patch embedding.

18. The system of claim 17, wherein determining the intermediate Q output based on the projected conditioning input embedding comprises:
processing the projected conditioning input embedding using a transformation function to generate a transformed conditioning input embedding; and
determining the intermediate Q output based on computing a product between (i) a learned V vector having values learned as the result of the training and (ii) the transformed conditioning input embedding.

19. The system of claim 17, wherein determining the intermediate K output based on projected observation patch embedding comprises:
for each of the plurality of observation patch embeddings:
processing the projected observation patch embedding using the transformation function to generate a transformed observation patch embedding; and
determining the intermediate K output based on computing a product between (i) the learned V vector and (ii) the transformed observation patch embedding.

20. A non-transitory computer storage medium encoded with instructions that, when executed by one or more computers, cause the one or more computers to perform operations for controlling an agent interacting with an environment, the operations comprising:
receiving an observation that characterizes the environment;
receiving a conditioning input that characterizes a task to be performed by the agent in the environment;
for each of a plurality of sub-regions of the observation, generating an observation patch embedding of the sub-region in an embedding space;
generating a conditioning input embedding of the conditioning input in the embedding space;
processing the observation patch embeddings and the conditioning input embedding to generate a policy output that defines an action to be performed by the agent in response to the observation, wherein the processing comprises applying a linear attention mechanism over the observation patch embeddings and the conditioning input embedding;
selecting an action to be performed by the agent using the policy output; and
causing the agent to perform the selected action.
